(19) United States
(12) Patent Application Publication
(10) Pub. No.: US 2013/0089444 A1
(43) Pub. Date: Apr. 11, 2013

(54) BRUSHLESS MOTOR AND ELECTRIC PUMP

(71) Applicant: AISAN KOGYO KABUSHIKI KAISHA, Aichi-ken (JP)

(72) Inventor: Atsushi Sugimoto, Aichi-ken (JP)

(73) Assignee: AISAN KOGYO KABUSHIKI KAISHA, Aichi-ken (JP)

(21) Appl. No.: 13/646,686

(22) Filed: Oct. 6, 2012

(30) Foreign Application Priority Data
Oct. 7, 2011 (JP) 2011-223066

(51) Int. Cl. H02K 1/18; F04D 13/06

(52) U.S. Cl. 417/423.7; 310/216.009

(57) ABSTRACT

A brushless motor includes a rotor and a stator. The stator includes yokes and a plurality of teeth. Base ends of the teeth are connected to the yokes, and tip ends of the teeth oppose an outside surface of the rotor with an interval in between. The plurality of teeth include a pair of first teeth connected to both ends of the yokes and second teeth connected to centers of the yokes. The first teeth are connected to the yokes in a first direction, and the second teeth are connected to the yokes in a second direction which is different from the first direction.

### CROSS-REFERENCE TO RELATED APPLICATION

This application claims priority to Japanese Patent Application No. 2011-223066 filed on Oct. 7, 2011, the contents of which are hereby incorporated by reference into the present application.

### TECHNICAL FIELD

The present teachings relate to a brushless motor and an electric pump.

### DESCRIPTION OF RELATED ART

Japanese Patent Application Publication No. 2006-340506 discloses a prior art brushless motor. The brushless motor includes a rotor and a stator disposed outside of the rotor. The stator includes two stator blocks having each stator block disposed on either side of the rotor. Each stator block includes a yoke and a plurality of teeth molded separately from the yoke. The plurality of teeth includes base ends connected to the yoke. Tip ends of the teeth oppose an outside surface of the rotor with intervals in between.

### BRIEF SUMMARY OF INVENTION

With the brushless motor described in the above described art, a manufacturing error or the like may cause a variation in lengths of the plurality of teeth connected to the yoke. In this case, if each tooth is positioned with reference to a rotor side surface of the yoke, a variation is created in the intervals between the teeth and the outside surface of the rotor. As a result, a variation is created in magnetic resistances among the teeth and causes a decline in motor efficiency or vibration during rotation of the motor.

On the other hand, when each tooth is positioned with reference to the outside surface of the rotor to even out the intervals between the tip ends of the teeth and the outside surface of the rotor, the teeth and/or the yoke deform in order to absorb the variation and a force is generated among these members. With the brushless motor according to the above described art, a base end surface of each tooth is connected so as to abut the rotor side surface of the yoke, and each tooth is connected to the yoke in a same direction. Therefore, in a part of the teeth, a force is generated in a direction that releases the connection of the teeth with the yoke and impairs the connecting conditions between the teeth and the yoke. As a result, a poor connection readily occurs between the teeth and the yoke and a variation in magnetic resistances is readily created among the teeth.

The present teachings provide a technique which enables intervals between teeth and an outside surface of a rotor to be evened out and which enables poor connections between the teeth and a yoke to be suppressed.

A brushless motor disclosed in the present specification comprises a rotor and a stator disposed outside of the rotor. The stator comprises at least two yokes disposed at an interval in a circumferential direction of the rotor, and at least three teeth arranged on each yoke. Each tooth includes a base end connected to the yoke, and a tip end opposing an outside surface of the rotor with an interval in between. The at least three teeth arranged on the same yoke comprise a pair of first teeth connected to both ends of the yoke, and a second tooth connected to a center of the yoke. In addition, the first teeth are connected to the yoke in a first direction, and the second tooth is connected to the yoke in a second direction which is different from the first direction.

With this brushless motor, a pair of first teeth is connected to both ends of a yoke, and a second tooth is connected to a center of the yoke. In addition, a direction in which the first teeth are connected to the yoke (a first connection direction) differs from a direction in which the second tooth is connected to the yoke (a second connection direction). Therefore, by positioning each tooth so that intervals between the tip ends of the teeth and the outside surface of the rotor are evened out, even if a force is generated between each tooth and the yoke, a direction of a force acting on the yoke from the first teeth is not consistent with a direction in which the second tooth disengages from the yoke, and a direction of a force acting on the yoke from the second tooth is not consistent with a direction in which the first teeth disengage from the yoke. As a result, the first teeth and the second tooth are prevented from disengaging from the yoke and a connection between each tooth and the yoke can be favorably maintained. Consequently, with this brushiess motor, the intervals between the teeth and an outside surface of a rotor can be evened out and poor connections between the teeth and the yoke can be suppressed.

### BRIEF DESCRIPTION OF DRAWINGS

FIG. 1 is a schematic longitudinal sectional view of an electric pump according to a first embodiment;

FIG. 2 is a diagram showing a stator and a rotor along line II-II in FIG. 1;

FIG. 3 is a diagram showing a stator of an electric pump according to a modification;

FIG. 4 is a diagram showing a stator of an electric pump according to a modification; and

FIG. 5 is a diagram showing a stator of an electric pump according to a modification.

### DETAILED DESCRIPTION OF INVENTION

In one aspect of a brushless motor, a stator may comprise a first yoke and a second yoke opposing the first yoke, and a rotor may be disposed between the first yoke and the second yoke. In this case, three parallel teeth may be connected to each of the first yoke and the second yoke. According to such a configuration, the stator can be formed flat and the brushless motor can be downsized.

In an aspect of the brushless motor described above, the second tooth connected to each yoke may be connected in the second direction perpendicular to a rotor side surface of the yoke, and the first teeth connected to each yoke may be connected in the first direction parallel to the rotor side surface of the yoke. According to such a configuration, since the direction in which the first teeth are connected to the yoke and the direction in which the second tooth is connected to the yoke are perpendicular to each other, a connection between each tooth and the yoke can be favorably maintained.

In another aspect of the brushless motor described above, the first teeth connected to each yoke may be connected in the first direction perpendicular to a rotor side surface of the yoke, and the second tooth connected to each yoke may be connected in the second direction parallel to the rotor side surface of the yoke. Even according to such a configuration, a connection between each tooth and the yoke can be favorably maintained.

In the brushless motor described above, favorably, the at least two yokes of the stator comprise a first yoke and a second yoke opposing the first yoke, the tip ends of the first teeth connected to the first yoke are connected to the tip end of the second tooth connected to the first yoke, and the tip ends of the first teeth connected to the first yoke are connected to the tip ends of the first teeth connected to the second yoke. According to such a configuration, since the tip ends of the teeth are connected, the teeth can be handled integrally and an operation for connecting the teeth to the yokes can be readily performed. Moreover, the term “connect” as used herein does not only mean integrally molding each tooth with a connecting portion that connects the teeth but also includes connecting each tooth using another member. Therefore, a case where each tooth is embedded in a resin material and the tip end of each tooth is connected by the resin material is also included in the term “connect” as used herein.

Furthermore, the present specification discloses a novel electric pump which uses the brushless motor described above. In other words, the electric pump disclosed in the present specification comprises any of the brushless motors described above, an impeller driven by the brushless motor, and a pump chamber accommodating the impeller, the impeller being capable of rotating in the pump chamber. Since the electric pump uses the brushless motor described above, pump efficiency can be increased.

Representative, non-limiting examples of the present teachings will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved brushiess motor, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

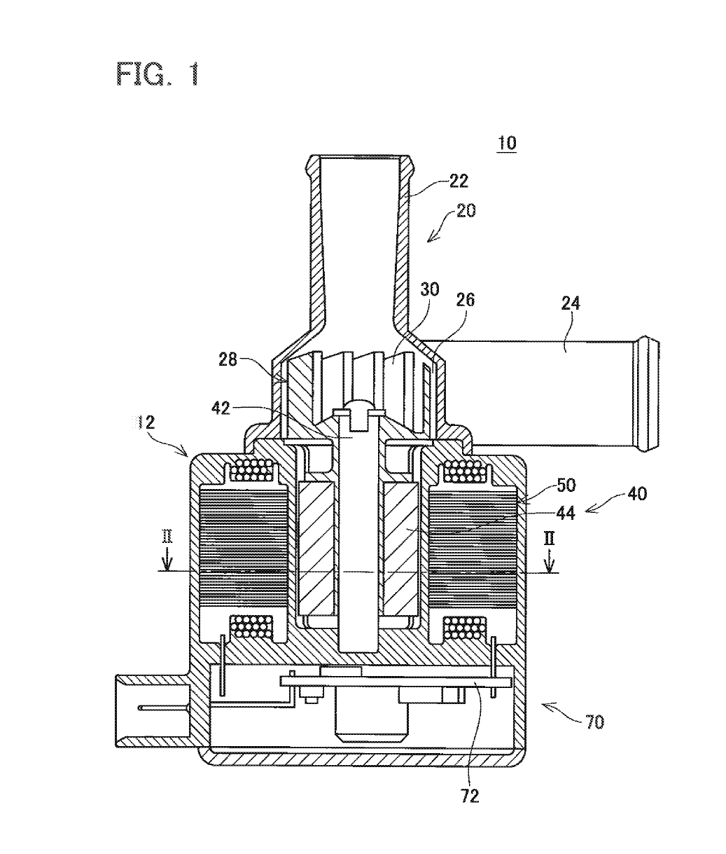

An electric pump 10 according to a first embodiment is installed in an engine room of an automobile and is used to circulate cooling water for cooling an engine, an inverter, and the like. As shown in FIG. 1, the electric pump 10 comprises a pump portion 20, a motor portion 40, and a circuit portion 70.

The pump portion 20 is formed above a casing 12. The pump portion 20 comprises a pump chamber 26. An inlet 22 and an outlet 24 formed in the casing 12 are connected to the pump chamber 26. The inlet 22 is connected to an upper end of the pump chamber 26. The inlet 22 extends in a direction in which an axis of rotation of a rotating body 28 extends. The outlet 24 is connected to an outside surface of the pump chamber 26. The outlet 24 extends in a tangential direction of the outside surface of the pump chamber 26. An impeller 30 of the rotating body 28 is disposed in the pump chamber 26.

The motor portion 40 is disposed below the pump portion 20. The motor portion 40 comprises a rigid shaft 42, the rotating body 28, and a stator 50. A lower end of the rigid shaft 42 is fixed to the casing 12. The rigid shaft 42 extends vertically in the casing 12 and a tip end of the rigid shaft 42 reaches inside the pump chamber 26. The rotating body 28 is attached to the rigid shaft 42 so as to be capable of rotating. The rotating body 28 comprises the impeller 30 and a rotor portion 44. A plurality of blades is formed at regular intervals on an upper surface of the impeller 30. The rotor portion 44 having a tubular shape is provided below the impeller 30. The rotor portion 44 is formed of a magnetic material and is magnetized so as to have a plurality of magnetic poles in a circumferential direction. The impeller 30 and the rotor portion 44 are integrally connected. Therefore, when the rotor portion 44 rotates, the impeller 30 rotates as well. The stator 50 is disposed outside the rotor portion 44 and opposes the rotor portion 44. A detailed configuration of the stator 50 will be described later.

The circuit portion 70 is disposed below the motor portion 40. The circuit portion 70 comprises a motor drive circuit 72 which controls feeding of power to the stator 50. The motor drive circuit 72 is connected to an external power supply (not shown; for example, a vehicle-mounted battery) by a wiring (not shown). The motor drive circuit 72 supplies power supplied from the external power supply to the motor portion 40.

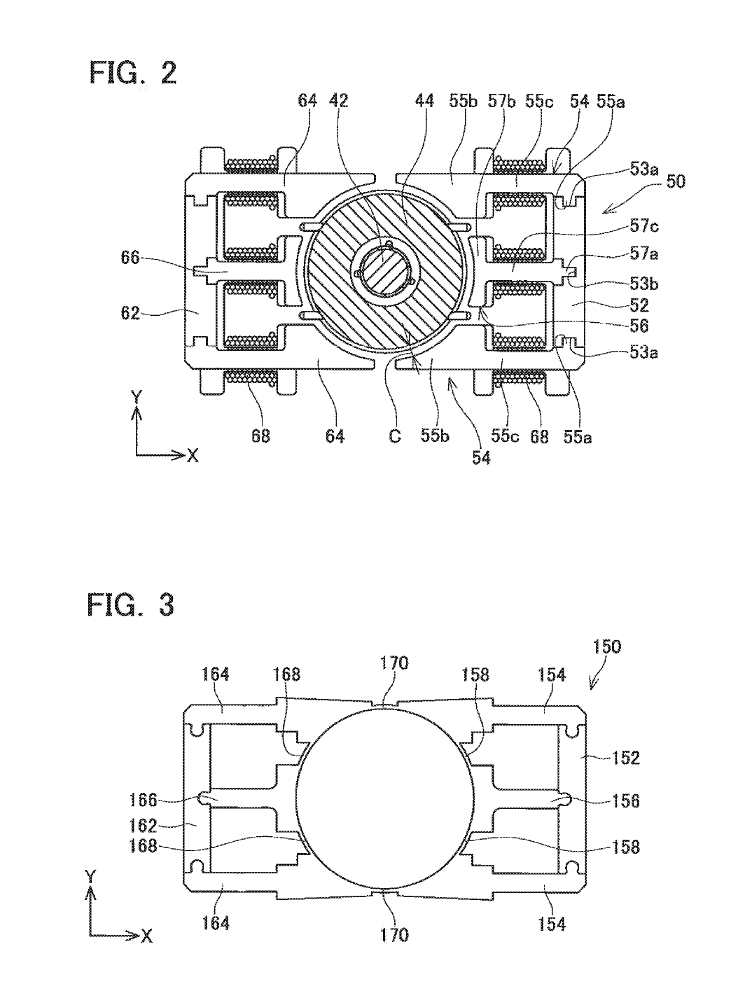

Next, the stator 50 will be described in greater detail. As shown in FIG. 1, the stator 50 is formed by laminating a plurality of magnetic steel sheets on one another. The stator 50 is embedded in the casing 12 and is surrounded by a resin material (in other words, a material of the casing 12). As shown in FIG. 2, the stator 50 comprises a pair of yokes 52 and 62, three teeth (54, 56, and 54) and (64, 66, and 64) respectively fixed to the yokes 52 and 62, and a coil 68 wound around each of the teeth (54, 56, and 54) and (64, 66, and 64).

The yokes 52 and 62 extend in a y axis direction as shown in FIG. 2 and are disposed at an interval in a circumferential direction of the rotor portion 44. In other words, the yokes 52 and 62 are disposed at an interval of 180 degrees in the circumferential direction of the rotor portion 44. As a result, the yokes 52 and 62 are symmetrically disposed with the rotor portion 44 in between. Moreover, the yoke 62 and the teeth (64, 66, and 64) have a same configuration as the yoke 52 and the teeth (54, 56, and 54) with a sole exception of being symmetrically disposed with respect to the rotor portion 44. Therefore, the yoke 52 and the teeth (54, 56, and 54) will be mainly described below.

Concave portions 53a and 53a are formed on both end surfaces of the yoke 52. In addition, a concave portion 53b is formed on a surface of the yoke 52 on a side of the rotor portion 44 (i.e., a surface opposing the yoke 62). The three teeth 54, 56, and 54 are connected to the yoke 52.

While base ends of the teeth 54, 56, and 54 are connected to the yoke 52, tip ends of the teeth 54, 56, and 54 oppose an outside surface of the rotor portion 44 with an interval C in between. In the present embodiment, each of the teeth 54, 56, and 54 is positioned with respect to the outside surface of the rotor portion 44 so that the interval C between the teeth 54, 56, and 54 and the outside surface of the rotor portion 44 is constant. In addition, the teeth 54, 56, and 54 are disposed parallel to each other and extend in an x direction. Therefore, as shown in FIG. 2, a cross section of the stator 50 (in other words, a cross section perpendicular to a rotational axis line of the rotor 44) has a rectangular shape with a long side that extends in the x direction and a short side that extends in the y direction. In other words, the stator 50 is a flat stator.

The three teeth 54, 56, and 54 are constituted by a pair of first teeth 54 and 54 connected to both ends of the yoke 52 and a second tooth 56 connected to a center of the yoke 52. Convex portions 55a and 55a are formed on base ends of the first teeth 54 and 54. The convex portions 55a and 55a are formed on surfaces that abut the yoke 52 or, in other words, on side surfaces of the first teeth 54 and 54. By having the convex portions 55a and 55a press-fitted into the concave portions 53a and 53a of the yoke 52, the first teeth 54 and 54 and the yoke 52 are connected to each other. Since the concave portions 53a and 53a are formed on the end surfaces of the yoke 52 and the convex portions 55a and 55a are formed on the end surfaces of the first teeth 54, the first teeth 54 are connected to the yoke 52 in a direction parallel to the surface of the yoke 52 on the side of the rotor portion 44 (in other words, the y axis direction). More specifically, the upper first tooth 54 shown in FIG. 2 is connected to the yoke 52 in a negative direction along the y axis, and the lower first tooth 54 shown in FIG. 2 is connected to the yoke 52 in a positive direction along the y axis. Moreover, tip ends 55b and 55b of the first teeth 54 and 54 are formed in a shape conforming to an outside shape of the rotor portion 44. In addition, the coil 68 is wound around middle portions 55c and 55c of the first teeth 54 and 54. The coil 68 is connected to the motor drive circuit 72 by a wiring (not shown).

A convex portion 57a is formed on a base end of the second tooth 56. The convex portion 57a is formed on a surface that abuts the yoke 52 or, in other words, on a base end surface of the second tooth 56. By having the convex portion 57a press-fitted into the concave portion 53b of the yoke 52, the second tooth 56 and the yoke 52 are connected to each other. Since the concave portion 53b is formed on an end surface of the yoke 52 (i.e., the surface opposing the rotor portion 44) and the convex portion 57a is formed on the base end surface of the second tooth 56, the second tooth 56 is connected to the yoke 52 in a direction perpendicular to the surface of the yoke 52 on the side of the rotor portion 44 (in other words, the x axis direction). Moreover, a tip end 57b of the second tooth 56 is formed in a shape conforming to the outside shape of the rotor portion 44. In addition, the coil 68 is wound around a middle portion 57c of the second tooth 56. The coil 68 is connected to the motor drive circuit 72 by a wiring (not shown).

As described earlier, the yoke 62 and the three teeth 64, 66, and 64 connected to the yoke 62 have the same configuration as the yoke 52 and the three teeth 54, 56, and 54 described above. In other words, the three teeth 64, 66, and 64 (first teeth 64 and 64, and a second tooth 66) are connected to the yoke 62. While base ends of the teeth 64, 66, and 64 are connected to the yoke 62, tip ends of the teeth 64, 66, and 64 oppose the outside surface of the rotor portion 44 with the interval C in between. Moreover, since a connecting structure between the yoke 62 and the teeth 64, 66, and 64 is the same as the connecting structure between the yoke 52 and the teeth 54, 56, and 54, a detailed description thereof will be omitted.

As shown in FIG. 1, the stator 50 described earlier is embedded in and integrated with the casing 12. In other words, the casing 12 and the stator 50 are integrally molded by insert molding. Upon the insert molding, the tip end of each of the teeth 54, 56, 54, 64, 66, and 64 is positioned in a die so that the interval C between each of the teeth 54, 56, 54, 64, 66, and 64 and the outside surface of the rotor portion 44 is constant, and a resin is injected into the die in this state to mold the casing 12. Therefore, the tip ends of the first teeth 54 connected to the yoke 52 are connected by the resin material to the tip end of the second tooth 56 and also connected by the resin material to the tip ends of the first teeth 64 connected to the yoke 62. In a similar manner, the tip ends of the first teeth 64 connected to the yoke 62 are connected by the resin material to the tip end of the second tooth 66 and also connected by the resin material to the tip ends of the first teeth 54 connected to the yoke 52. Accordingly, a position of each of the teeth 54, 56, 54, 64, 66, and 64 is prevented from deviating during rotation of the rotor portion 44 and, as a result, a variation in intervals between adjacent teeth and a variation in intervals between tip ends of the teeth and the rotor portion 44 are reduced.

In addition, in the present embodiment, the tip end of each of the teeth 54, 56, 54, 64, 66, and 64 is positioned with respect to the outside surface of the rotor portion 44 during insert molding in order to even out the intervals between the tip ends of the teeth 54, 56, 54, 64, 66, and 64 and the outside surface of the rotor portion 44. Therefore, when lengths of the teeth 54, 56, 54, 64, 66, and 64 vary with respect to designed values, an internal force is generated between each of the teeth 54, 56, 54, 64, 66, and 64 and the yokes 52 and 62. At this point, since the directions in which the teeth 54, 56, 54, 64, 66, and 64 are connected to the yokes 52 and 62 are different, connections between the teeth 54, 56, 54, 64, 66, and 64 and the yokes 52 and 62 can be mutually suppressed from becoming poor connections, For example, when the length of the second tooth 56 is longer than a designed value, the second tooth 56 presses the yoke 52 outward (in the x axis direction shown in FIG. 2). However, the first teeth 54 and 54 are connected to the yoke 52 in the y axis direction which is perpendicular to a direction of a force acting on the yoke 56 from the second tooth 56. As a result, connections between the teeth 54, 56, and 54 and the yoke 52 are favorably maintained.

For example, when the length of the first teeth 54 and 54 is longer than a designed value, the first teeth 54 and 54 press the yoke 52 outward (in the x axis direction shown in FIG. 1). Therefore, a force acting on the yoke 52 from the first teeth 54 and 54 is consistent with a direction in which the second tooth 56 disengages from the yoke 52. However, by setting the length of the second tooth 56 somewhat longer so that a compressive force is constantly generated between the second tooth 56 and the yoke 52 even if the lengths of the teeth 54, 56, and 54 deviate from designed values, the connection between the second tooth 56 and the yoke 52 can be favorably maintained.

Next, operations of the electric pump 10 will be described. When power is supplied to the coil 68 from the motor drive circuit 72, the rotor portion 44 rotates around the rigid shaft 42. As a result, the impeller 30 rotates and cooling water is suctioned into the pump chamber 26 via the inlet 22. Pressure of the cooling water suctioned into the pump chamber 26 is increased by the rotation of the impeller 30 and the cooling water is discharged to outside of the casing 12 from the outlet 24.

As described above, according to the present embodiment, the interval between the teeth 54, 56, 54, 64, 66, and 64 and the outside surface of the rotor portion 44 is constant and, at the same time, the teeth 54, 56, 54, 64, 66, and 64 and the yoke 52 and 62 are connected to each other in a favorably manner. Therefore, a variation in magnetic resistances among the teeth 54, 56, 54, 64, 66, and 64 is suppressed, and an improvement in motor efficiency and a reduction in vibration during rotation are achieved. As a result, the electric pump 10 according to the present embodiment has high pump efficiency and suppressed discharge rate variation.

The preferred embodiments of the present teachings have been described above, the explanation was given using, as an example, the present teachings is not limited to this type of configuration.

For example, a shape of the stator is not limited to that according to the embodiment described above and may be shaped as shown in FIG. 3. As shown in FIG. 3, although a stator 150 is configured approximately the same as the stator 50 described above, the stator 150 differs from the stator 50 in that the stator 150 comprises connectors 158, 168, and 170 which connect tip ends of adjacent teeth 154, 156, 164,and 166. Specifically, in the stator 150, a tip end of a first tooth 154 connected to a yoke 152 is connected by the connector 158 to a tip end of a second tooth 156 and also connected by the connector 170 to a tip end of a first tooth 164 connected to a yoke 162. In a similar manner, the tip end of the first tooth 164 connected to the yoke 162 is connected by the connector 168 to a tip end of a second tooth 166 and also connected to the tip end of the first tooth 154 connected to the yoke 152. By comprising the connectors 158, 168, and 170, the teeth 154, 156, 164, and 166 can be handled integrally and operations for assembly to the yokes 152 and 162 can be readily performed. In addition, intervals between adjacent teeth can be prevented from varying and a variation in magnetic resistances among the respective teeth can be suitably suppressed. Moreover, the stator 150 shown in FIG. 3 also differs in shapes of convex portions of the teeth 154, 156, 164, and 166 and shapes of concave portions of the yokes 152 and 162.

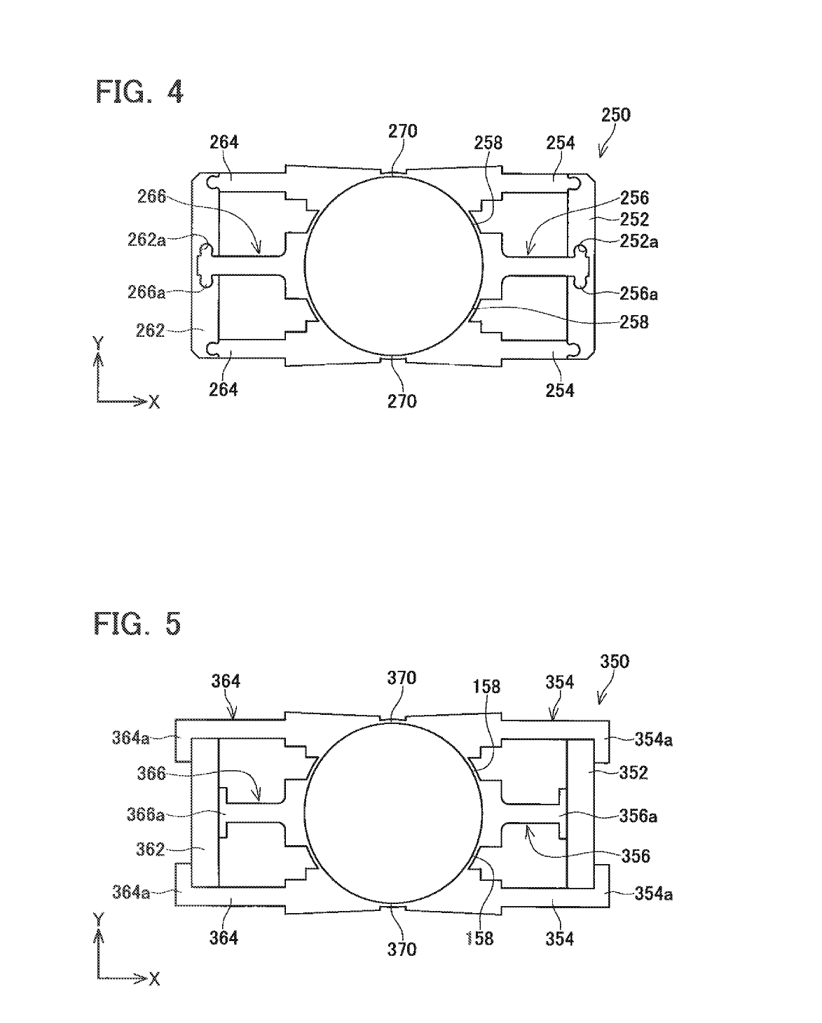

Alternatively, a stator shape such as that shown in FIG. 4 may be adopted. As shown in FIG. 4, although a stator 250 is configured approximately the same as the stator 150 described above, the stator 250 differs from the stator 150 in directions in which teeth 254, 256, 264, and 266 are connected to yokes 252 and 262. Specifically, in the stator 250, convex portions are formed on base end surfaces of first teeth 254 and 264, whereby the convex portions are press-fit into concave portions formed on rotor side surfaces of the yokes 262 and 262. In other words, the first teeth 254 and 264 are connected to the yokes 252 and 262 in a direction perpendicular to the rotor side surfaces of the yokes 262 and 262 (an x axis direction).

Meanwhile, protruding portions 256a and 266a which greatly protrude sideways are formed at base ends of second teeth 256 and 266, whereby the protruding portions 256a and 266a are press-fitted into concave portions 252a and 262a formed on the yokes 252 and 262. Since the protruding portions 256a and 266a greatly protrude sideways, the second teeth 256 and 266 are connected to the yokes 255 and 266 in a direction perpendicular to a paper plane of FIG. 4 other words, a direction parallel to a rotor side surface of the yokes 252 and 262). Even according to such a configuration, since the direction in which the first teeth 254 and 264 are connected to the yokes 252 and 262 and the direction in which the second teeth 256 and 266 are connected to the yokes 252 and 262 are perpendicular to each other, connections between the teeth 254, 256, 264, and 266 and the yokes 252 and 262 are favorably maintained.

Moreover, when connecting the teeth 254, 256, 264, and 266 and the yokes 252 and 262 to each other, the protruding portions 256a and 266a of the second teeth 256 and 266 are first press-fitted into the concave portions 252a and 262a of the yokes 252 and 262 from a direction perpendicular to a paper plane in FIG. 4. In this state, since the first teeth 254 and 264 and the yokes 252 and 262 are not connected to each other, the yokes 252 and 262 bendingly deform so that centers thereof become convex toward a rotor side. Next, the convex portions of the first teeth 254 and 264 are press-fitted into the concave portions of the yoke 252 and 262. Accordingly, the teeth 254, 256, 264, and 266 and the yokes 252 and 262 can be connected to each other.

Furthermore, a stater shape such as that shown in FIG. 5 may also be adopted. As shown in FIG. 5, although a stator 350 is configured approximately the same as the stator 150 shown in FIG. 3, the stator 350 differs from the stator 150 in a connecting structure between teeth 354, 356, 364, and 366 and yokes 352 and 362. Specifically, in the stator 350, bent portions 354a and 364a which are bent inward are formed at base ends of first teeth 354 and 364. The bent portions 354a and 364a abut a non-rotor side of the yokes 352 and 362. On the other hand, abutting portions 356a and 366a are formed on base ends of the second teeth 356 and 366. The abutting portions 356a and 366a abut a rotor side of the yokes 352 and 362. Lengths of the teeth 354, 356, 364, and 366 are set so that the first teeth 354 and 364 press the yokes 352 and 362 toward a rotor side and the second teeth 356 and 366 press the yokes 352 and 362 toward a non-rotor side. Since the direction in which the first teeth 354 and 364 press the yokes 352 and 362 and the direction in which the second teeth 356 and 366 press the yokes 352 and 362 are opposite to each other, sufficient contact pressure is secured between the teeth 354, 356, 364, and 366 and the yokes 352 and 362. Therefore, a favorable connecting condition between each of the teeth 354, 356, 364, and 366 and the yokes 352 and 362 can be achieved.

Moreover, when connecting the teeth 354, 356, 364, and 366 to the yokes 352 and 362, abutting portions 356a and 366a of the second teeth are first abutted to rotor side surfaces of the yokes 352 and 362. Next, the first teeth 354 and 364 are bent in a y axis direction, and the bent portions 354a and 364a are abutted using a restoring force of the first teeth 354 and 364 to non-rotor side surfaces of the yokes 352 and 362. Therefore, in the stator 350, the first teeth 354 and 364 are connected to the yokes 352 and 362 in a direction perpendicular to the rotor side surfaces of the yoke 362 and 362 (the x axis direction). On the other hand, the second teeth 356 and 366 are connected to the yokes 352 and 362 in a direction parallel to the rotor side surfaces of the yoke 362 and 362 (the y axis direction). As a result, even in the stator 350, the direction in which the first teeth 354 and 364 are connected to the yokes 352 and 362 and the direction in which the second teeth 356 and 366 are connected to the yokes 352 and 362 are perpendicular to each other, and connections between the teeth 354, 356, 364, and 366 and the yokes 352 and 362 are favorably maintained.

In addition, in the stator 350, side surfaces of the first teeth 354 and 364 press both ends surfaces of the yokes 352 and 362 and deform the yokes 352 and 362 in a compressing direction. As a result, a variation in intervals between adjacent teeth 354, 356, 364, and 366 is suppressed and a variation in magnetic resistances among the teeth is suitably suppressed.

Moreover, while the teeth and the yokes are connected to each other by forming convex portions on the teeth and forming concave portions on the yokes in the aforementioned embodiments shown in FIGS. 2, 3, and 4, conversely, the teeth and the yokes may be connected to each other by forming concave portions on the teeth and forming convex portions on the yokes. In addition, while configurations of pairs which consist of a yoke and teeth and which are respectively disposed symmetrically with respect to the rotor are the same in the embodiments described above, the configurations of the pairs may differ from each other.

What is claimed is:

1. A brushless motor comprising:
a rotor; and
a stator disposed outside of the rotor; wherein
the stator comprises at least two yokes disposed at an interval in a circumferential direction, and at least three teeth arranged on each yoke,
each tooth includes a base end connected to the yoke, and a tip end opposing an outside surface of the rotor with an interval in between,
the at least three teeth arranged on the same yoke comprise a pair of first teeth connected to both ends of the yoke, and a second tooth connected to a center of the yoke,
the first teeth are connected to the yoke in a first direction, and
the second tooth is connected to the yoke in a second direction which is different from the first direction.

2. The brushless motor as in claim 1, wherein
the at least two yokes of the stator comprise a first yoke and a second yoke opposing the first yoke,
the rotor is disposed between the first yoke and the second yoke, and
the at least three teeth arranged on each of the first yoke and the second yoke comprise three parallel teeth.

3. The brushless motor as in claim 2, wherein
the second tooth is connected to each yoke in the second direction perpendicular to a rotor side surface of the yoke, and
the first teeth are connected to each yoke in the first direction parallel to the rotor side surface of the yoke.

4. The brushless motor as in claim 3, wherein
the tip ends of the first teeth connected to the first yoke are connected to the tip end of the second tooth connected to the first yoke, and
the tip ends of the first teeth connected to the first yoke arc connected to the tip ends of the first teeth connected to the second yoke.

5. The brushless motor as in claim 2, wherein
the first teeth are connected to each yoke in the first direction perpendicular to a rotor side urface of the yoke, and
the second tooth is connected to each yoke in the second direction parallel to the rotor side surface of the yoke.

6. The brushless motor as in claim 5, wherein
the tip ends of the first teeth connected to the first yoke are connected to the tip end of the second tooth connected to the first yoke, and
the tip ends of the first teeth connected to the first yoke are connected to e tip ends of the first teeth connected to the second yoke.

7. An electric pump comprising:
a brushless motor as in claim 1;
an impeller driven by the brushless motor, and
a pump chamber accommodating the impeller, the impeller being capable of rotating in the pump chamber.
